(19) United States
(12) Patent Application Publication
(10) Pub. No.: US 2026/0010279 A1
(43) Pub. Date: Jan. 8, 2026

(54) Observation Assistance Device

(71) Applicant: Hitachi High-Tech Corporation, Minato-ku, Tokyo (JP)

(72) Inventors: Wei Chean TAN, Tokyo (JP); Hiroyuki CHIBA, Tokyo (JP); Hiromi MISE, Tokyo (JP)

(21) Appl. No.: 18/993,220

(22) PCT Filed: Sep. 6, 2022
(86) PCT No.: PCT/JP2022/033400

§ 371 Date: Jan. 10, 2025

(51) Int. Cl. G06F 3/04845; G06F 3/0482; G06T 3/40

(52) U.S. Cl. CPC G06F 3/04845; G06F 3/0482; G06T 3/40

(57) ABSTRACT

An observation assistance device for a sample includes an observation position display unit that displays, in correspondence with an image display section, positions of a plurality of captured images of the sample which are captured by a charged particle beam device, a display processing unit that controls the observation position display unit, and a representative image selection processing unit that selects a representative image on the basis of the plurality of captured images, in which the display processing unit controls the representative image to a size that is easy to view and displays the representative image on the observation position display unit in response to a change in a magnification of the image display section.

### TECHNICAL FIELD

The present invention relates to an observation assistance device, and more particularly to an observation assistance device for assisting observation using a charged particle beam device.

### BACKGROUND ART

A charged particle beam device is a device that operates the surface of a sample with a finely focused charged particle beam in a vacuum and detects signals output from the sample to generate a two-dimensional profile image of the surface of the sample. Since observation is performed in a vacuum, an observation sample cannot be visually confirmed. In order to specify an observation position on a sample, an observation assistance function of displaying an image captured at a magnification lower than an observation magnification and presenting the observation position on the captured low-magnification image is known.

PTL 1 is an example of the related art in this technical field. PTL 1 discloses that, “by displaying a plurality of observation position display images with different magnifications on an observation position display unit in an overlapping manner on the basis of a magnification and coordinates at which an observation image is acquired, an observation position can be presented even when the magnification of the observation image and the magnification of the image displaying the observation position are significantly different”.

### CITATION LIST

### Patent Literature

PTL 1: WO17/090100A

### SUMMARY OF INVENTION

### Technical Problem

In a device disclosed in PTL 1, a plurality of observation position display images with different magnifications are displayed on an observation position display unit in an overlapping manner on the basis of a magnification and coordinates at which an observation image is acquired so that the observation position can be presented even when the magnification of the current observation (magnification of the observation image) is significantly different from the magnification of the image displaying the observation position.

However, in the method of PTL 1, when the magnification of the observation position display unit is significantly different from the magnification of the image being displayed, it is easy to lose sight of the image being displayed, and it is difficult to specify the observation position of the image.

The present invention has been made to solve such problems, and an object thereof is to provide an observation assistance device that can prevent losing sight of the position of an observation position display image even when the current magnification of an observation position display unit is significantly different from the magnification of the observation position display image.

### Solution to Problem

An example of an observation assistance device for a sample according to the present invention is an observation assistance device for a sample, including an observation position display unit that displays, in correspondence with an image display section, positions of a plurality of captured images of the sample which are captured by a charged particle beam device, a display processing unit that controls the observation position display unit, and a representative image selection processing unit that selects a representative image on the basis of the plurality of captured images, in which the display processing unit controls the representative image to a size that is easy to view and displays the representative image on the observation position display unit in response to a change in a magnification of the image display section.

An example of an observation assistance device for a sample according to the present invention is an observation assistance device for a sample, including an observation position display unit that displays, in correspondence with an image display section, positions of a plurality of captured images of the sample which are captured by a charged particle beam device, a display processing unit that controls the observation position display unit, and a representative image selection processing unit that selects a representative image on the basis of the plurality of captured images, in which the observation assistance device extracts a predetermined region and groups the captured images on the basis of the predetermined region.

### Advantageous Effects of Invention

According to the present invention, even when the current magnification of an observation position display unit is significantly different from the magnification of an observation position display image, it is possible to prevent losing sight of the position of the observation position display image.

Further features related to the present invention will become apparent from the description of this specification and the accompanying drawings. In addition, problems, configurations, and effects other than those described above will become apparent from the description of the following examples.

### BRIEF DESCRIPTION OF DRAWINGS

FIG. 1 is an example of a schematic diagram of a charged particle beam device according to Example 1 of the present invention.

FIG. 2A is an example of an observation position display screen of the charged particle beam device according to Example 1 of the present invention.

FIG. 2B is an example of an observation position display screen of the charged particle beam device according to Example 1 of the present invention.

FIG. 2C is an example of an observation position display screen of the charged particle beam device according to Example 1 of the present invention.

FIG. 2D is an example of an observation position display screen of the charged particle beam device according to Example 1 of the present invention.

FIG. 2E is an example of an observation position display screen of the charged particle beam device according to Example 1 of the present invention.

FIG. 2F is an example of an observation position display screen of the charged particle beam device according to Example 1 of the present invention.

FIG. 3A is an example of an observation position display screen of a charged particle beam device according to Example 2 of the present invention.

FIG. 3B is an example of an observation position display screen of the charged particle beam device according to Example 2 of the present invention.

FIG. 3C is an example of an observation position display screen of the charged particle beam device according to Example 2 of the present invention.

FIG. 3D is an example of an observation position display screen of the charged particle beam device according to Example 2 of the present invention.

FIG. 3E is an example of an observation position display screen of the charged particle beam device according to Example 2 of the present invention.

FIG. 3F is an example of an observation position display screen of the charged particle beam device according to Example 2 of the present invention.

FIG. 3G is an example of an observation position display screen of the charged particle beam device according to Example 2 of the present invention.

FIG. 3H is an example of an observation position display screen of the charged particle beam device according to Example 2 of the present invention.

FIG. 4A is an example of an observation position display screen of a charged particle beam device according to Example 3 of the present invention.

FIG. 4B is an example of an observation position display screen of the charged particle beam device according to Example 3 of the present invention.

FIG. 4C is an example of an observation position display screen of the charged particle beam device according to Example 3 of the present invention.

FIG. 4D is an example of an observation position display screen of the charged particle beam device according to Example 3 of the present invention.

FIG. 4E is an example of an observation position display screen of the charged particle beam device according to Example 3 of the present invention.

FIG. 4F is an example of an observation position display screen of the charged particle beam device according to Example 3 of the present invention.

FIG. 4G is an example of an observation position display screen of the charged particle beam device according to Example 3 of the present invention.

FIG. 5A is an example of an observation position display screen of a charged particle beam device according to Example 4 of the present invention.

FIG. 5B is an example of an observation position display screen of the charged particle beam device according to Example 4 of the present invention.

FIG. 6 is a setting screen for grouping conditions for captured images and selection conditions for representative images.

FIG. 7 is a setting screen for grouping conditions for images of interest that are analysis results of captured images and selection conditions for representative images.

### DESCRIPTION OF EMBODIMENTS

Hereinafter, examples of the present invention will be described with reference to the accompanying drawings. In the accompanying drawings, functionally the same elements may be denoted by the same or corresponding numbers. The accompanying drawings show examples and implementation examples according to the principles of the present disclosure, but these are for the purpose of understanding the present disclosure and are not used to interpret the present disclosure in a limited manner at all. The description in this specification is merely a typical example and does not limit the scope of the claims or application examples of the present disclosure in any sense.

This specification provides a detailed description sufficient for a person skilled in the art to implement the present disclosure, but it is necessary to understand that other implementations and forms can be made, and that changes to the configuration and structure and replacement of various elements can be made without departing from the scope and spirit of the technical ideas of the present disclosure. Thus, the following description should not be interpreted as being limited thereto.

A charged particle beam device is a device that accelerates particles having charged (charged particles) such as electrons and cations in an electric field and irradiates a sample with the charged particles. A charged particle beam device uses interaction between a sample and charged particles to perform observation, analysis, processing, and the like on the sample. The examples to be described below can be applied to various charged particle beam devices (electron microscopes, electron beam lithography devices, ion processing devices, ion microscopes, observation and inspection devices using these devices, and the like).

### Example 1

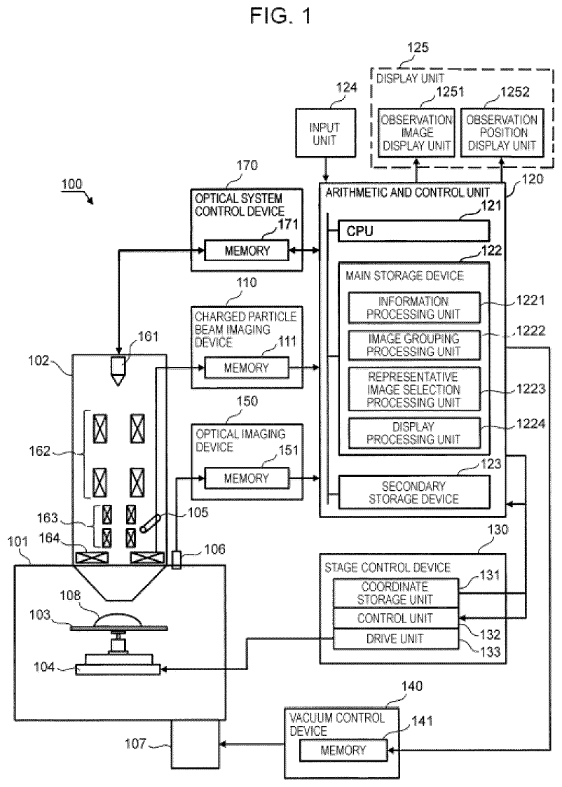

The overall configuration of a charged particle beam device 100 according to Example 1 of the present invention will be described with reference to FIG. 1. As an example, the charged particle beam device 100 includes a sample chamber 101, a charged particle beam optical system 102, a sample stage 103, a stage 104, a detector 105, a vacuum pump 107, a charged particle beam imaging device 110, an arithmetic control unit 120, a stage control device 130, an optical imaging device 150, and a vacuum control device 140.

The sample chamber 101 has a function of maintaining a vacuum state inside so that a charged particle beam does not scatter, and is configured such that a sample can be mounted inside. The vacuum pump 107 can be controlled by the vacuum control device 140 to execute a vacuum pumping operation of the sample chamber 101. The vacuum control device 140 may include a memory 141 for storing various parameters related to vacuum control.

The charged particle beam optical system 102 includes a charged particle source 161 that generates an electron beam, a condenser lens 162 that narrows the electron beam emitted from the charged particle source 161, a deflector 163 that deflects the electron beam, an objective lens 164 that converges the electron beam, and the like.

The optical system control device 170 includes a memory 171 for storing various parameters related to the control of the charged particle beam optical system 102, and has a function of generating an electron beam from the charged particle source 161, narrowing the electron beam with the condenser lens 162, and performing control so that the electron beam is deflected and converged by the deflector 163 and the objective lens 164 and emitted to a sample 108 mounted on the sample stage 103.

The configuration in FIG. 1 is an example, and the charged particle beam optical system 102 may include other lenses and electrodes in addition to the elements shown in the drawing, or some of the elements may be replaced with other similar elements, and details of the configuration are not limited to those shown in the drawing.

The sample stage 103 is mounted on the stage 104. The stage 104 can move the sample stage 103 in the XY direction (for example, vertical and horizontal directions) within the sample chamber 101. The sample stage 103 can rotate around a rotation axis (for example, parallel to the Z axis). The sample stage 103 holds the sample so as to be able to be inclined with the X-direction or Y-direction as an inclined axis. The stage 104 is controlled by the stage control device 130 in accordance with arithmetic results of the arithmetic control unit 120.

The detector 105 has a function of detecting reflected electrons, secondary electrons, backscattered electrons (such as those due to EBSD: Electron Back Scattered Diffraction Pattern), inelastically scattered electrons (such as those related to EELS: Electron Energy Loss Spectroscopy), Auger electrons, cathodoluminescence (CL), X-rays (such as those related to EDS: Energy Dispersive X-ray Spectroscopy or WDS: Wavelength Dispersive X-ray Spectroscopy), and the like emitted from the sample 108.

Although only one detector 105 is shown in FIG. 1, the number and position of the detector 105 are not limited to a specific one. By moving the stage 104 relative to an imaging range (visual field) of an optical camera 106, an image of the entire sample 108 for navigation purposes is acquired.

The charged particle beam imaging device 110 has a function of converting a signal detected by the detector 105 into an image, and includes a memory 111 for storing signal information therein. The optical imaging device 150 also has a function of capturing an optical image of the sample 108 in the sample chamber 101 with the optical camera 106 and converting the imaging signal into an optical image. The optical imaging device 150 includes a memory 151 for storing the optical image therein.

The arithmetic control unit 120 is a control unit that controls various components of the charged particle beam device 100 and controls the display of observation results in accordance with observation conditions input by a user. The arithmetic control unit 120 is configured with an information processing device such as a computer. The arithmetic control unit 120 includes, for example, a CPU 121 (processor), a main storage device 122 such as a memory, and a secondary storage device 123 such as a hard disk drive (HDD) or a solid state drive (SSD).

The arithmetic control unit 120 also includes an input unit 124 such as a keyboard, a mouse, or a touch monitor, a display unit 125 such as a liquid crystal display (observation image display unit 1251 and observation position display unit 1252), and a communication unit (not shown) that communicates with each component of the charged particle beam device 100.

The arithmetic control unit 120 and the display unit 125 configure an observation assistance device for a sample according to this example, and assist the observation of an image of the sample captured by the charged particle beam device 100. In this example, the observation assistance device is configured as a part of the charged particle beam device 100, but the observation assistance device of the present invention may be configured independently of the charged particle beam device 100. In this case, for example, an image output from the charged particle beam device 100 may be acquired and the observation of the image may be assisted.

The main storage device 122 stores a computer program that controls the operation of the entire charged particle beam device 100. The computer program is executed by the CPU 121 to provide functional blocks such as an information processing unit 1221, an image grouping processing unit 1222, a representative image selection processing unit 1223, a display processing unit 1224, and the like.

The information processing unit 1221 is a processing unit that collectively processes information such as an acceleration voltage, an emission current, a magnification, a beam spot, and a working distance acquired from the optical system control device 170, information such as signals, an image name, an image resolution, a visual field range, an imaging time, and a time required for imaging acquired from the charged particle beam imaging device 110, information such as an optical image name, an optical image resolution, a visual field range, imaging time, and a time required for imaging acquired from the optical imaging device 150, information such as stage coordinates acquired from the stage control device 130, and information such as a vacuum degree acquired from the vacuum control device 140, and outputs the information as attribute information of the image.

The image grouping processing unit 1222 is a control unit for performing grouping process on the acquired optical image of the sample 108 or the image (observation image) converted from the signal. The representative image selection processing unit 1223 is a processing unit for selecting one or more representative images from the image group obtained through the grouping process.

The display processing unit 1224 is a processing unit for performing display processing of the acquired optical image of the sample 108 or the image (observation image) converted from the signal on the basis of information (attribute information at the time of imaging) such as stage coordinates, a stage rotation angle, a magnification, and a raster rotation. Furthermore, the display processing unit 1224 controls the observation position display unit 1252. For example, even when the magnification of a representative image and the magnification of the observation position display unit 1252 are significantly different, the display processing unit 1224 performs processing on the representative image so that the representative image is displayed at all times in a size that is easy to view.

In this example, the representative image is an image of which the display magnification or display size is controlled at all times to have a size that is easy to view so that sight of the display position of an image satisfying a certain determined condition is not lost in the image group input to the observation position display unit 1252, but it should not be interpreted as being limited thereto.

The stage control device 130 includes a coordinate storage unit 131, a control unit 132, and a drive unit 133. The coordinate storage unit 131 stores the coordinates of the stage 104. The control unit 132 controls the operation of the entire stage control device 130. The drive unit 133 generates a drive signal to drive the stage 104. The control unit 132 acquires stage coordinate information from the coordinate storage unit 131 and transmits the acquired stage coordinate information to the arithmetic control unit 120. Thereby, the arithmetic control unit 120 can know the coordinate position of the captured image. The stage coordinates may be stored in the stage control device 130 or the arithmetic control unit 120.

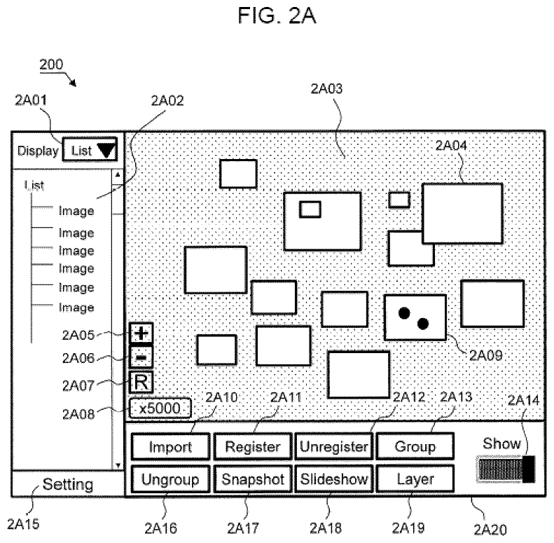

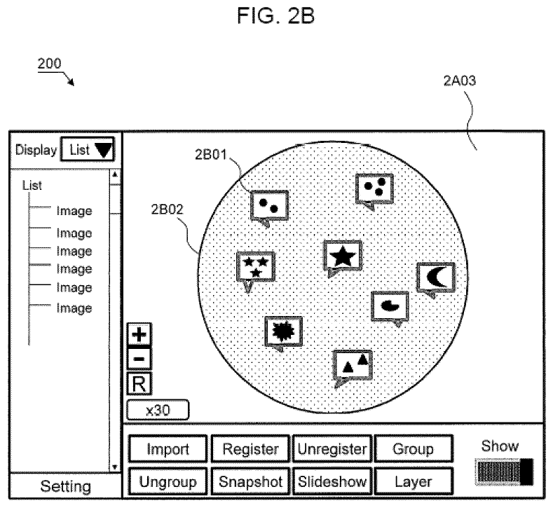

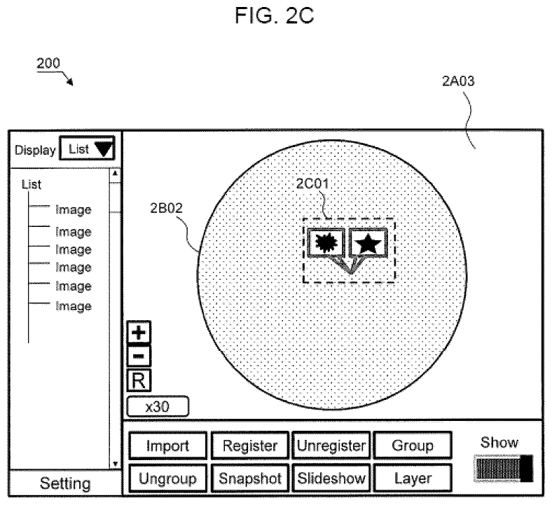

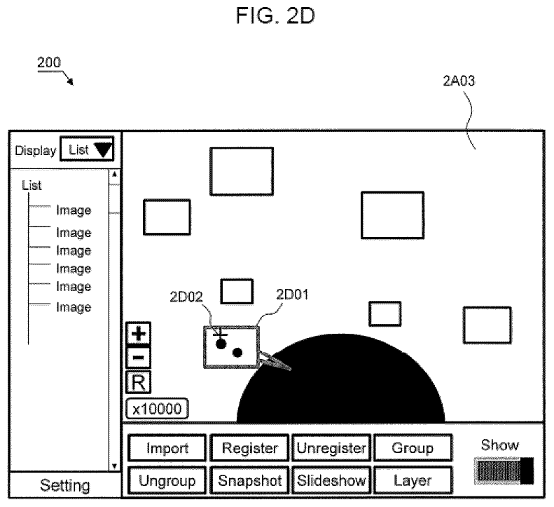

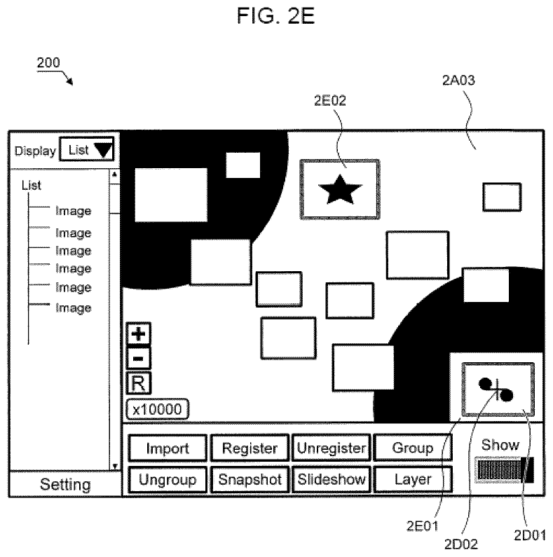

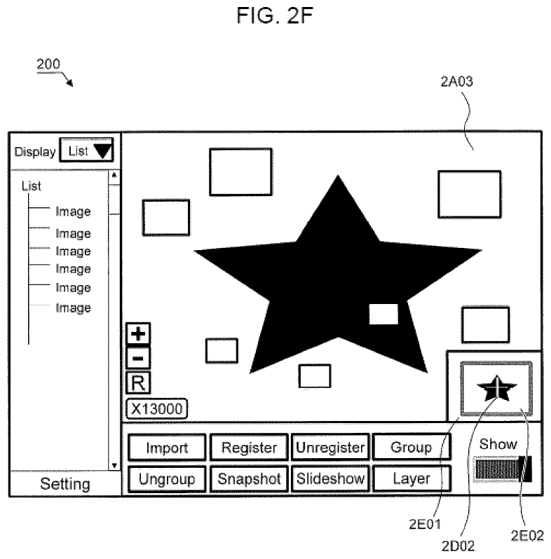

FIGS. 2A to 2F show examples of an observation position display screen of the charged particle beam device 100 according to Example 1. FIG. 2A is an example of a screen shown on the observation position display unit 1252. Such a screen can be implemented as an observation position display screen 200 displayed on the observation position display unit 1252.

The observation position display screen 200 includes an image name list display section 2A02, an image display section 2A03, and an operation section 2A20. The image name list display section 2A02 is a display section that displays a list of image names of a group of input images in a tree structure. In the example of FIG. 2A, an image name list display switching section 2A01 can switch the display of image names to a list display or a group display by tag name.

The image display section 2A03 is a display section that displays input images on the basis of information such as an imaging magnification, stage coordinates, and raster rotation (image attribute information at the time of image acquisition). The image display section 2A03 can be configured as, for example, a virtual drawing canvas. The operation section 2A20 is an operation section for performing operations such as image input (image input button 2A10) and representative image registration (representative image registration button 2A11).

The image display section 2A03 is a position reference and displays an image of a sample which is captured by the charged particle beam device 100. The displayed image includes a background image and a captured image of which the position is indicated in relation to the image display section 2A03.

The image display section 2A03 is aligned (associated) with the stage coordinates of the charged particle beam device 100, and the position in the image display section 2A03 corresponding to each part of the sample can be appropriately determined. As a more specific example, when the stage coordinates are expressed as (Xs, Ys) and the coordinates (pixel coordinates) of the image display section 2A03 are expressed as (Xp, Yp), a function for determining Xp and Yp on the basis of Xs and Ys is specified.

A method for performing such alignment can be appropriately designed by a person skilled in the art on the basis of known technology, but for example, a three-point alignment process or a dedicated sample holder may be used.

The background image displayed on the image display section 2A03 is, for example, an image of a sample which is captured by the charged particle beam device 100, but the present invention is not limited thereto. The background image is, for example, an image displayed on the image display section 2A03 in a size that matches the screen. It is also possible not to display the background image (in this case, the background displayed on the image display section 2A03 may be blank, or another predetermined display may be performed).

The captured image is an image of a sample which is captured by the charged particle beam device 100, for example, a display image 2A04. The observation position display unit 1252 displays the positions of a plurality of display images 2A04 as a plurality of captured images in association with the image display section 2A03. For example, an image captured by the charged particle beam device 100 is displayed on the image display section 2A03 aligned with the stage coordinates of the charged particle beam device 100.

The image display section 2A03 has a variable magnification (that is, inversely proportional to the visual field). The magnification of the image display section 2A03 can be calculated on the basis of the alignment with the stage coordinates of the charged particle beam device 100. For example, the background image and the captured image such as the display image 2A04 each have a magnification at the time of acquisition, and thus, when the magnification of the image display section 2A03 is increased, parts of the background image and the captured image are zoomed and displayed (that is, the number of pixels on one side at the time of display is variable).

The observation position display unit 1252 can display the image display section 2A03 (or the background image displayed on the image display section 2A03) and the captured image at a size ratio according to their respective magnifications. For example, when the magnification of the image display section 2A03 is 5,000 times, the magnification of the captured image is 20,000 times, and the number of pixels of the image display section 2A03 and the number of pixels at the time of capturing the captured image are the same, the captured image is reduced and displayed so that the size of the captured image on the screen is ¼ the size of the image display section 2A03.

The following is a more specific description using an example. It is assumed that the number of pixels of the image display section 2A03 is 1280×960 pixels, and the original magnification is 20,000 times. It is also assumed that the number of pixels of the captured image at the time of imaging is 1280×960 pixels, and the magnification at the time of imaging is 20,000 times. In this case, the size of the captured image matches the size of the image display section 2A03, and the captured image is initially displayed as it is in a size of 1280×960 pixels. When the number of pixels at the time of imaging is different, the different original size of the captured image is determined accordingly.

When the magnification of the image display section 2A03 is decreased (that is, the visual field is widened), the size of the captured image needs to be reduced in accordance with the decreased magnification. For example, when the magnification of the image display section 2A03 is set to 10,000 times, which is half of the original magnification, the size of the captured image is also set to 640×480 pixels, which is half of the original size (at the time of imaging). When the magnification of the image display section 2A03 is set to 5,000 times, which is ¼ of the original magnification, the size of the captured image is also set to 320×240 pixels, which is ¼ of the original size (at the time of imaging).

In contrast, when the magnification of the image display section 2A03 is increased (that is, the visual field is narrowed), the size of the captured image needs to be enlarged in accordance with the increased magnification. For example, when the magnification of the image display section 2A03 is set to 40,000 times, which is twice the original magnification, the size of the captured image is also set to 2560×1920 pixels, which is twice the original size (at the time of imaging).

In the above-mentioned example, a size S1 of the captured image is changed such that the changed size S1 of the captured image is a size obtained by multiplying the original size S0 of the captured image by a ratio (X1/X0) of the original magnification X0 of the image display section 2A03 to the changed magnification X1 of the image display section 2A03, that is, S1=S0×X1/X0.

A method of determining display contents when the size of the captured image is changed can be appropriately designed by a person skilled in the art on the basis of known technology. For example, when the size is reduced, some of the pixels may be thinned out, and when the size is enlarged, some of the pixels may be generated by interpolation.

Next, a case where the magnification of the image display section 2A03 is extremely lower than the magnification of the captured image (for example, the display image 2A04) will be described. For example, when the magnification of the image display section 2A03 is 5,000 times and a captured image with a magnification higher than 5,000 times is input, the image is displayed as shown in FIG. 2A.

The observation position display unit 1252 displays a magnification increase button 2A05, a magnification decrease button 2A06, a magnification reset button 2A07, and a magnification display section 2A08.

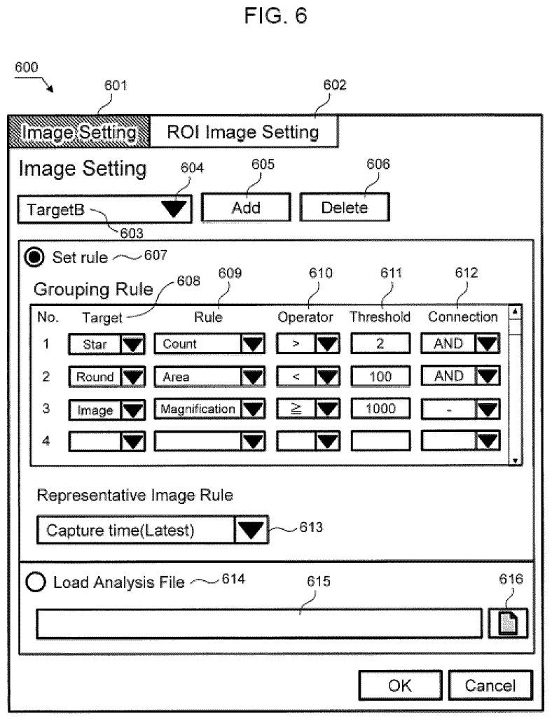

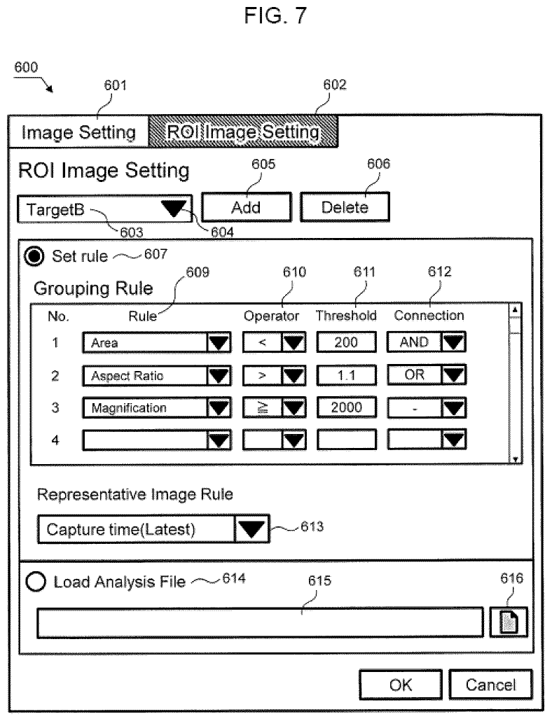

Here, it is assumed that there is a condition achievement image 2A09 that satisfies a predetermined condition among the captured images (this condition can be input, for example, via a GUI shown in FIGS. 6 and 7, which will be described later). In addition, it is assumed that the magnification of the image display section 2A03 becomes extremely lower (for example, switched to 30 times) than the magnification of the condition achievement image 2A09 by reducing the display magnification of the image display section 2A03 using the magnification decrease button 2A06 or by operating a mouse, or resetting the display magnification of the image display section 2A03 to the minimum magnification by operating the magnification reset button 2A07.

Even in this case, according to this example, as shown in the example of FIG. 2B, the condition achievement image 2A09 is at all times controlled to a size that is easy to view, and is then displayed as a representative image 2B01 surrounded by a balloon frame. In this manner, the display processing unit 1224 controls the representative image 2B01 to a size that is easy to view and displays it on the observation position display unit 1252 in response to a change in the magnification of the image display section 2A03.

The representative image selection processing unit 1223 selects the representative image 2B01 on the basis of a plurality of captured images. The specific selection process can be designed as appropriate, but for example, all of the condition achievement images 2A09 may be set as the representative image 2B01, the representative image 2B01 may be selected from among the condition achievement images 2A09 on the basis of a specific rule, or an image corresponding to a partial region included in the condition achievement image 2A09 may be set as the representative image 2B01.

Furthermore, the base of the balloon frame is displayed so as to point to the coordinates of the representative image 2B01 in a displayed sample map 2B02 at the time of observation or acquisition of the image. In the example of FIG. 2B, the sample map is displayed, but the sample map may not be displayed, or something other than the sample map may be displayed. Furthermore, the representative image 2B01 is displayed using a balloon frame, but a frame of a different shape may be used, or a frame may not be used.

In this example, the base of the balloon frame is used to indicate the coordinates of the representative image 2B01, but a different shape such as an arrow may be used, or the image may be cut out and displayed without using an arrow.

When the representative image is disposed at an observation position and displayed, an arrow or the like may not be displayed, but when the position of the representative image is changed by dragging the mouse, an arrow or the like may be displayed such that the original position of the image can be seen.

In this example, the size of an image is a size (for example, expressed in units of the number of pixels) when the image is displayed on the screen, and does not necessarily correspond to the amount of data of the image (for example, the number of pixels at the time of imaging). That is, the same image can be displayed in various sizes by enlarging or reducing the image.

In this example, the “controlling the representative image 2B01 to a size that is easy to view” includes, for example, controlling the representative image 2B01 to a specific size. The “specific size” may be, for example, a fixed size regardless of the magnification of the image display section 2A03.

Specific processing for realizing such a size change can be appropriately designed by a person skilled in the art on the basis of known technology, and an example is shown below. For example, when it is assumed that the virtual size (visual field) corresponding to the image display section 2A03 is 254 mm and the virtual size (visual field) of the representative image 2B01 is 127 mm, the representative image 2B01 is displayed in a size half the size of the image display section 2A03.

Here, it is assumed that the magnification of the image display section 2A03 is reduced to half of the original magnification. In this case, the visual field of the image display section 2A03 is 508 mm, which is twice the original visual field. If the visual field of the representative image 2B01 is not changed but maintained at 127 mm, the visual field of the representative image 2B01 is ¼ of the visual field of the image display section 2A03, and thus the size of the representative image 2B01 is also ¼ of the size of the image display section 2A03. Thus, the size of the representative image 2B01 changes and is not fixed.

In this example, in order to fix the size of the representative image 2B01, the visual field of the representative image 2B01 is changed depending on the visual field of the image display section 2A03. For example, when the visual field of the image display section 2A03 is 508 mm which is twice the original visual field, the size of the representative image 2B01 can be fixed and displayed by accordingly setting the visual field of the representative image 2B01 to 254 mm, which is twice the original visual field. Similarly, when the visual field of the image display section 2A03 is 1016 mm which is four times the original visual field, the visual field of the representative image 2B01 can be accordingly set to 508 mm, which is four times the original visual field.

The above-mentioned specific processing can also be implemented as control using a display layer. The virtual size of the display layer corresponding to the image display section 2A03 can be set as the visual field of the image display section 2A03, and the virtual size of the display layer including the representative image 2B01 can be set as the visual field of the representative image 2B01.

Alternatively, the above-mentioned “specific size” may be a size that changes depending on the magnification of the image display section 2A03, but is a size that is not simply proportional to the magnification of the image display section 2A03 (for example, the changed size of the captured image is calculated as a size different from S1 mentioned above; that is, the size is calculated as a size different from S1=S0×x X1/X0 which is the size S1 obtained by multiplying the original size S0 of the captured image by a ratio (X1/X0) of the changed magnification X1 of the image display section 2A03 to the original magnification X0 of the image display section 2A03). For example, as the magnification of the image display section 2A03 decreases, it is also possible to gradually reduce the size of the representative image 2B01 at a pace lower than the pace of decrease in the magnification.

According to such control, the representative image 2B01 can be displayed in a size that is easier to view.

In the example of FIG. 2B, the user can manually register a representative image. That is, the representative image selection processing unit 1223 may select, as the representative image, the captured image indicated by a manual input among the captured images. For example, when the representative image registration button 2A11 is clicked in a state where a single or a plurality of captured images in the image display section 2A03 are selected or a single or a plurality of image names on the image name list display section 2A02 are selected, the selected images are registered as the representative images 2B01.

On the other hand, when an image that has been registered as a representative image is selected and the representative image cancellation button 2A12 is clicked, it is possible to cancel the registration state of the representative image 2B01. When the magnification of the image display section 2A03 is extremely lower than the magnification of the captured image in a case where a plurality of representative images located at positions close to each other are registered, a plurality of representative images 2C01 are spaced apart from each other as shown in FIG. 2C, and the positions of the bases of respective balloon frames designate the positions close to each other.

By operating a representative image display toggle button 2A14, it is possible to switch between displaying and not displaying the representative image 2B01 on the image display section 2A03 (when the representative image 2B01 is not displayed, all representative images 2B01 are not displayed). This switching between displaying and not displaying may be performed regardless of the magnification of the image display section 2A03.

Next, a case where the display magnification of the image display section 2A03 is extremely higher than the magnification of an image being displayed will be described. In the example of FIG. 2D, when the magnification of the image display section 2A03 is increased to 10,000 times centering on the condition achievement image 2A09 in FIG. 2A, the condition achievement image 2A09 is displayed as a representative image 2D01 (representative image No.2) in a size that is easy to view so that sight of the condition achievement image 2A09 is not lost.

Furthermore, a characteristic part may be or may not be designated by the base of a balloon frame or by an arrow or the like so that the position of the representative image 2D01 can be specified, and the present invention is not limited to that shown in the drawing.

Operations such as moving the representative image 2D01 by dragging a mouse or enlarging or reducing a display size can be performed. Alternatively, as shown in the example of FIG. 2E, an auxiliary display 2E01 may be displayed in a lower right part of the image display section 2A03 so as not to lose sight of the condition achievement image 2A09, and the condition achievement image 2A09 may be displayed on the auxiliary display 2E01 in a size that is easy to view as the representative image 2D01. That is, controlling the representative image 2D01 to a size that is easy to view includes controlling the representative image 2D01 to the size of the auxiliary display 2E01 and displaying it on the auxiliary display 2E01.

Here, the “controlling the size of the representative image 2D01 to the size of the auxiliary display 2E01” means changing the size of the representative image 2D01 to the maximum size (that is, the maximum size at which the representative image 2D01 does not extend beyond the region) at which the entire representative image 2D01 is displayed in a predetermined region (which may be the entire region) of the auxiliary display 2E01, as shown in FIG. 2E, for example.

According to such control, the representative image 2D01 is displayed at a fixed position at all times, making it easier to view.

Furthermore, in order to make it easier to specify the current observation position, a position display marker 2D02 is displayed on the representative image 2D01. In the examples of FIGS. 2D and 2E, the position display marker 2D02 is shown as a cross marker, but the position display marker may be displayed in a different shape, or a display range may be displayed as a frame, and the present invention is not limited to that shown in the drawing.

Furthermore, in FIG. 2F, when the magnification of the image display section 2A03 is increased to, for example, 13,000 times centering on the representative image 2E02 (representative image No.3), a representative image to be displayed is switched. For example, the display image of the auxiliary display 2E01, or the representative image 2D01 as shown in FIG. 2D is switched to the representative image 2E02. The representative image may be switched manually or automatically depending on the magnification of the image display section 2A03 and the current observation position, and the present invention is not limited to that shown in the drawing.

Furthermore, when there are a plurality of representative images at positions close to each other, the plurality of representative images may be displayed on the auxiliary display 2E01 in a size that is easy to view, or may be grouped and displayed as one representative image in a size that is easy to view.

In addition, the size or magnification of the representative image displayed on the auxiliary display 2E01 may be changed, and the display of the representative image may be changed by performing a dragging operation on the auxiliary display 2E01 using a mouse, changing the magnification, or the like, and the present invention is not limited to this example. In this example, a representative image selection process is performed manually or in accordance with preset conditions, but the representative image selection process may be performed randomly and is not limited to this example.

When the magnification of the image display section 2A03 is significantly different from the magnification of the representative image 2B01, the representative image 2B01 is controlled to a size that is easy to view or is displayed on the auxiliary display 2E01 in a size that is easy to view, making it easy to specify an observation position without losing sight of the representative image 2B01.

### Example 2

Example 2 of the present invention will be described below. Descriptions of parts that are in common with those in Example 1 may be omitted.

Captured images may or may not be grouped. In the case of a grouping process, when a grouping button 2A13 of an operation section 2A20 is clicked in a state where a single or a plurality of captured images in an image display section 2A03 are selected, or a single or a plurality of image names on an image name list display section 2A02 are selected, a grouping process for the selected images is performed.

In contrast, when a grouping cancellation button 2A16 of the operation section 2A20 is clicked in a state where a single or a plurality of captured images for which the grouping process has been performed are selected from the image display section 2A03, or a single or a plurality of image names on the image name list display section 2A02 are selected, the grouping is cancelled.

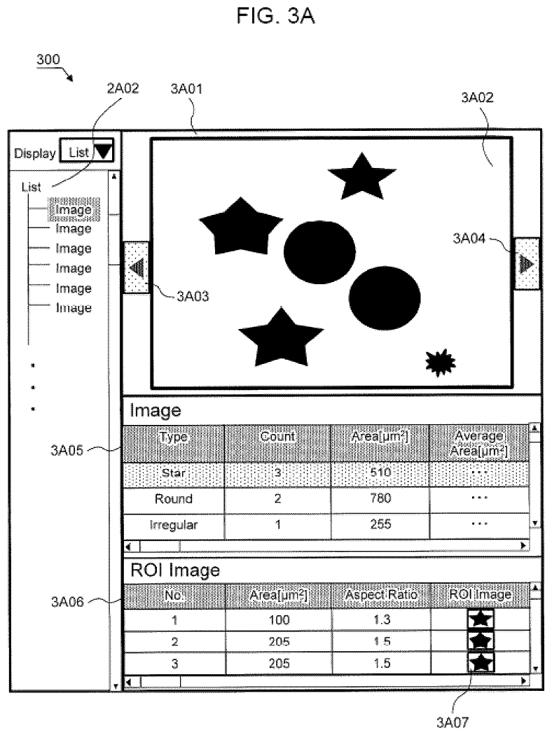

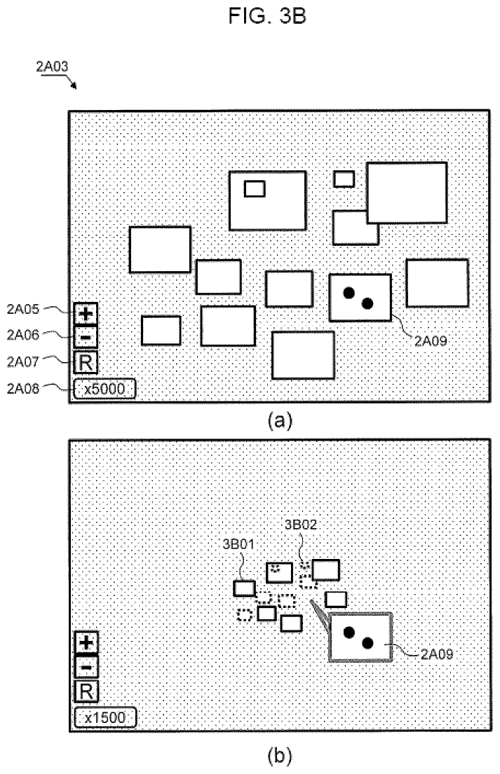

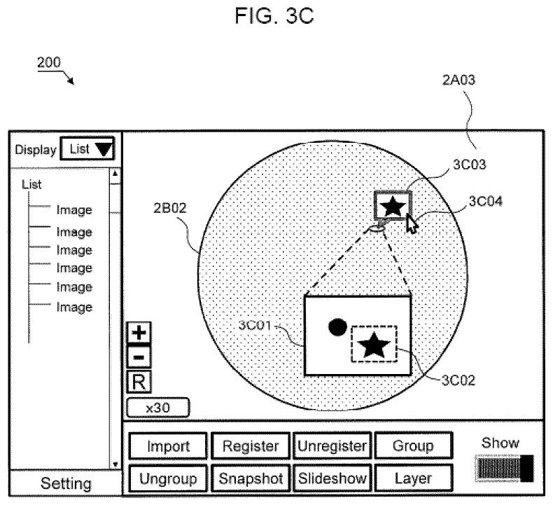

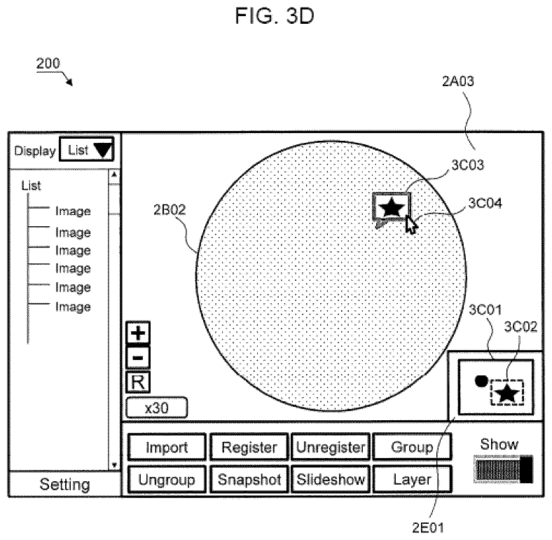

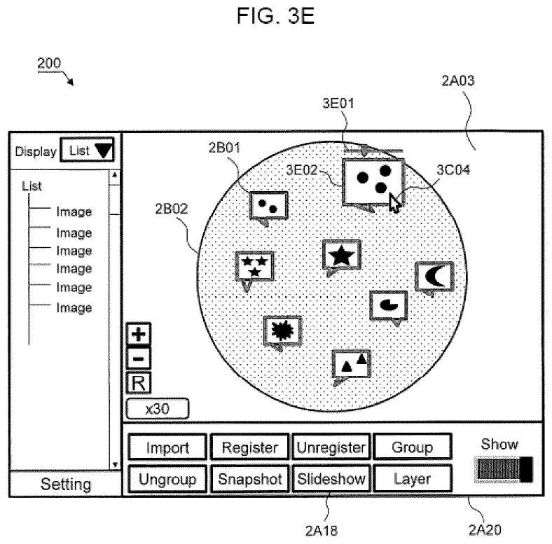

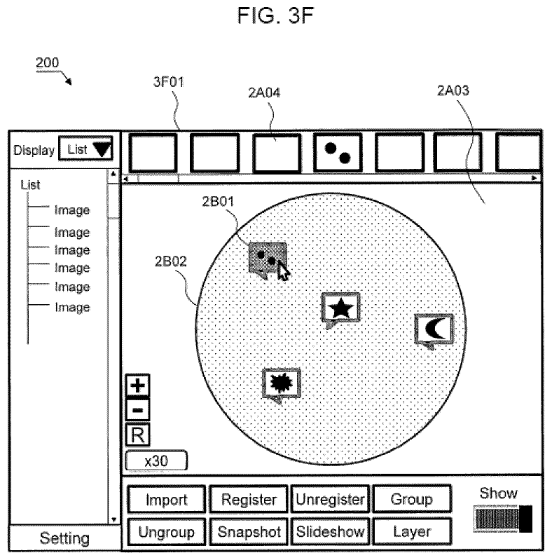

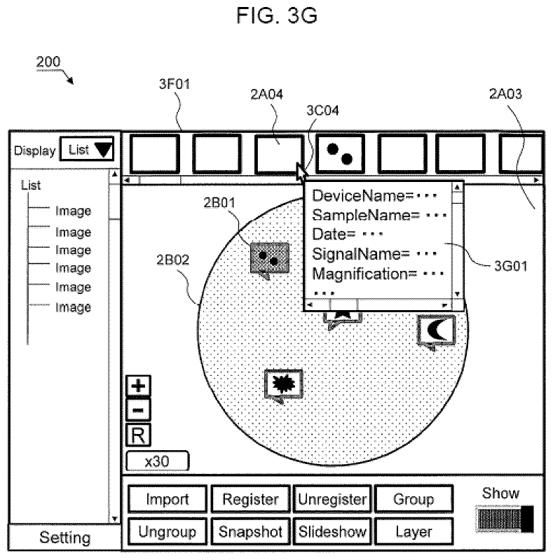

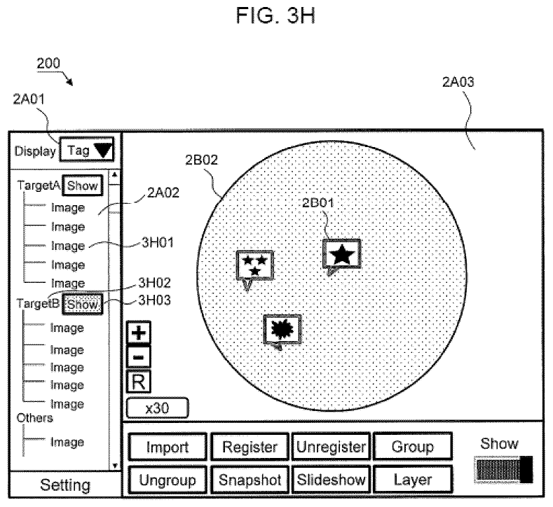

FIGS. 3A to 3H show examples of an observation position display screen of a charged particle beam device 100 according to Example 2. In this example, it is assumed that image analysis is performed at a timing when an image is input. FIG. 3A shows an image analysis result display screen 300. This screen is displayed on the display unit 125 of FIG. 1.

The image analysis result display screen 300 includes the image name list display section 2A02, a target image display section 3A01, an image analysis information display section 3A05, and a particle analysis information display section 3A06. The image name list display section 2A02 displays a list of image names of input images (captured images). When any image name is selected in the image name list display section 2A02, the selected image is displayed on the target image display section 3A01.

Analysis information of a target image 3A02 is displayed on the image analysis information display section 3A05, and when a result in the image analysis information display section 3A05 is selected, detailed analysis information of the selected target result and an image of interest 3A07 (ROI image) are displayed on the particle analysis information display section 3A06. By clicking a left button 3A03 or a right button 3A04 on the target image display section 3A01, it is possible to switch between the target image 3A02 and analysis information thereof.

As described above, when the input captured image and the image of interest 3A07 (ROI image), which is the analysis result of the captured image, each have analysis information, it is possible to perform an image grouping process and a representative image selection process on the basis of this analysis information.

First, a grouping process and a representative image selection process for each captured image will be described. When a setting screen 600 (FIG. 6) is called up from an input image setting section 2A15 and an image setting tab 601 is selected, it is possible to set a grouping process and a representative image selection process for an input captured image.

First, a group page is added using a group page addition button 605. When a grouping condition setting radio button 607 is selected, it is possible to set grouping conditions simply. For example, it is possible to set an image or an analysis target in an image from an analysis target setting unit 608, and further set grouping processing conditions based on corresponding image attribute information or image analysis information by a condition setting unit 609.

Thereafter, conditions are set in a relationship setting unit 610 and a threshold value setting unit 611. When a plurality of feature values are set, a relationship between the conditions can be set by an inter-condition relationship setting unit 612.

When a single or a plurality of representative images 2B01 are selected from a group of captured images belonging to the same group, selection conditions can be set by a representative image selection condition setting unit 613, and the representative images can be selected on the basis of the set selection conditions. In the example of FIG. 6, a condition of the latest imaging time is set.

A representative image selection processing unit 1223 may select a representative image in accordance with representative image selection conditions on the basis of image analysis information or image attribute information of each captured image. Here, the image attribute information according to this example is specific information associated with an image, such as an image name at the time of image acquisition, imaging time, a time required for imaging, a magnification, a signal, and a resolution. In addition, the image analysis information according to this example is feature values (including the type of analysis object in the image, a count number, an area, an average area, a distribution, class classification, element information, crystal orientation information, and the like obtained by image processing, processing by artificial intelligence (AI), a machine learning process, an EDS analysis process, a crystal orientation analysis process and the like) and information indicating a relationship between images (including a distance between images (for example, a distance in a color space), class classification, similarity between images, and the like).

According to such control, an appropriate representative image can be automatically selected.

An image grouping processing unit 1222 groups captured images. For example, the image grouping processing unit 1222 groups captured images indicated by a manual input among the captured images into the same group.

Alternatively, the image grouping processing unit 1222 groups the captured images on the basis of image analysis information or image attribute information of each captured image. According to such control, a plurality of images having a common feature can be collectively processed, and a large number of images can be more efficiently viewed.

As conditions for grouping, image attribute information such as an acquisition time of the captured images and image analysis information of the captured images may be used, or information other than the image attribute information and the image analysis information may be used as conditions.

The settings of the analysis target setting unit 608, the condition setting unit 609, and the representative image selection condition setting unit 613 may be set from the analysis information displayed on the image analysis information display section 3A05 in FIG. 3A, or other information (for example, image attribute information) may be set, and the present invention is not limited to those shown in the drawing.

On the other hand, when an analysis file setting radio button 614 is selected, an analysis file path can be input to a file path input unit 615 or opened by a file selection button 616. When the contents of an analysis file include grouping conditions and representative image selection conditions, a grouping process and a representative image selection process are performed in accordance with the conditions.

When a grouping page is deleted, a page is selected by a grouping page selection unit 604, and a group page deletion button 606 is clicked to delete the selected page. In this example, the grouping process and the representative image selection process are performed manually or in accordance with preset conditions, but the image grouping process and the representative image selection process may be performed randomly and are not limited to this example.

FIG. 3B shows an operation of displaying a condition achievement image 2A09 (representative image) and images other than the representative image when the display magnification of the image display section 2A03 is changed.

As shown in FIG. 3B(a), the display magnification of the image display section 2A03 is 5,000 times, and the condition achievement image 2A09 and other images are displayed in different sizes on the basis of the respective image magnifications. Here, when the display magnification of the image display section 2A03 is reduced to 1,500 times as shown in FIG. 3B(b), the condition achievement image 2A09 is displayed in a size that is easy to view. In contrast, the display size of each captured image other than the condition achievement image 2A09 may be gradually reduced depending on the display magnification of the image display section 2A03 (reduced image 3B01), or the display of the image may be omitted in accordance with preset conditions such as a threshold value of a certain determined magnification (non-display image 3B02; for convenience of description, the image not being displayed is indicated by a dashed line in FIG. 3B(b)). That is, the observation assistance device according to this example controls a captured image other than a representative image to a size corresponding to the magnification of the image display section 2A03 (for example, a size simply proportional to the magnification of the image display section 2A03; that is, a size obtained by multiplying the original size S0 of the captured image by a ratio (X1/X0) of the original magnification X0 of the image display section 2A03 to the changed magnification X1 of the image display section 2A03, that is, a size where S1=S0×X1/X0), or omits the display of captured images other than the representative image depending on the magnification of the image display section 2A03.

According to such control, the size of an image other than the representative image changes depending on the magnification of the image display section 2A03, and thus it is easier to grasp a relationship between images on the entire screen.

Alternatively, regardless of the magnification of the image display section 2A03, it is possible to switch between display and non-display of a selected image from a right-click menu (not shown) or the like in a state where any one of the displayed condition achievement image 2A09 and the other captured images is selected using a mouse pointer (an example of a position input pointer; other position input pointers may also be used; the same applies below). In this example, the use of the mouse pointer is described, but a touch operation or the like may also be used.

In addition to the right-click menu for switching between display and non-display of images, a check box for switching between display and non-display of images may be provided next to each image name in an image name tree view displayed on the image name list display section 2A02, and this should not be interpreted in a restrictive manner.

Next, a grouping process and a representative image selection process for the image of interest 3A07 (ROI image), which is the analysis result of the input captured image, can be set from an interest image setting tab 602 of the setting screen 600 (FIG. 7). The image of interest 3A07 can be a representative image.

The setting of the grouping process and the representative image selection process for the image of interest 3A07 (ROI image), which is the analysis result, is similar to the setting of the captured image described above, but it is not necessary to set an analysis target. In addition, the setting of the condition setting unit 609 and the representative image selection condition setting unit 613 may be set from detailed analysis information displayed on the particle analysis information display section 3A06 in FIG. 3A, or other information (for example, image attribute information) may be set, and the present invention is not limited to that shown in the drawing.

The “detailed analysis information” according to this example is feature values of each image of interest 3A07 (ROI image) (obtained by image processing, processing by artificial intelligence (AI), a machine learning process, an EDS analysis process, a crystal orientation analysis process and the like; for example, the type of analysis object in the image of interest 3A07 (ROI image), an area, circularity, class classification, element information, crystal orientation information, and the like are included) and information indicating a relationship between images (including a distance between images of interest 3A07 (ROI images) (for example, a distance in a color space), class classification, similarity between images, and the like).

As shown in FIG. 3C, when a representative image selection condition (for example, a condition set in the representative image selection condition setting unit 613 in FIGS. 6 and 7) is satisfied from a group of images of interest that are analysis results of captured images, an image of interest 3C03 (ROI image) of a condition achievement interest target 3C02 is selected as a representative image from a display image 3C01 (captured image) in which a plurality of types of particles or foreign matter are mixed, and when the magnification of the image display section 2A03 becomes extremely lower than the magnification of the captured image, the image of interest 3C03 is displayed as a representative image.

In this manner, the representative image selection processing unit 1223 selects one of the captured images as a representative image in Example 1, but in this example, the representative image selection processing unit 1223 selects an image of interest that occupies a predetermined region in one of the captured images as a representative image. According to such control, a target to be particularly noticed is displayed in a size that is easier to view.

When a mouse over operation is performed on the image of interest 3C03 with a mouse pointer 3C04 (“mouse over” means, for example, disposing the mouse pointer 3C04 over the image of interest 3C03), the display image 3C01, which is the original image in which a plurality of types of particles or foreign matter are mixed, may be displayed on the image display section 2A03 as shown in FIG. 3C, or may be displayed on the auxiliary display 2E01 in a size that is easier to view as shown in FIG. 3D, and the present invention is not limited to that shown in the drawing.

In this example, it is not necessary to set an analysis target for an image of interest (ROI image), but an analysis target may be set, and the present invention is not limited to that shown in the drawing. In this example, an image of interest (ROI image) which is an analysis result of each captured image is generated in advance, but an image of interest may be generated at a timing when the analysis result satisfies a representative image selection condition, and the present invention is not limited to that shown in the drawing.

The representative image selection processing unit 1223 may set an image designated by the mouse pointer among grouped captured images as a representative image. In addition, when a grouping process is performed on a group of input captured images, a representative image is enlarged when a mouse over operation is performed on the representative image with the mouse pointer 3C04 as shown in FIG. 3E. That is, controlling the representative image to a size that is easy to view includes enlarging the representative image in response to the designation by the mouse pointer.

According to such control, it is easier to view the representative image.

The observation position display unit 1252 enlarges one of the representative images and displays a slider bar of a group image in relation to the enlarged representative image. In the example of FIG. 3E, a slider bar 3E01 is displayed above an enlarged representative image 3E02.

When the slider bar 3E01 is kept displayed for a certain period of time, representative images enlarged and displayed at the position of the enlarged representative image 3E02 are switched sequentially from the same group at fixed time intervals (slide show), and the position of the slider on the slider bar is changed accordingly. The switching of the representative images is not limited to switching at fixed time intervals, but may be performed by moving a mouse wheel up and down or manually moving the slider on the slider bar.

At this time, the representative image may be changed. For example, the representative image selection processing unit 1223 may select a representative image from among the grouped captured images while switching them for a predetermined time. That is, a representative image is switched as time passes.

According to such control, a plurality of captured images can be efficiently viewed.

When a slide show button 2A18 of the operation section 2A20 is clicked, a slide show is started simultaneously for all representative images displayed on the image display section 2A03. However, in this case, the representative images may or may not be enlarged, and the present invention is not limited to that shown in the drawing. In addition, a slider bar may or may not be displayed, or something other than the slider bar may be displayed, and the present invention is not limited to that shown in the drawing.

As shown in FIG. 3F, the representative image 2B01 on the image display section 2A03 may be selected, and a group image list display section 3F01 may be displayed from a right-click menu (not shown). The group image list display section 3F01 displays a list of captured images belonging to the same group as the selected representative image 2B01.

According to such control, it becomes easier to grasp images in units of groups.

In addition, as shown in FIG. 3G, when a mouse over operation is performed on a display image 2A04 (captured image) on the group image list display section 3F01 using the mouse pointer 3C04, an image information display pop-up window 3G01 showing attribute information and analysis information of the display image 2A04 is displayed. That is, when any of the captured images displayed in the list is designated by the mouse pointer 3C04, the observation position display unit 1252 displays at least one of image attribute information and image analysis information for the designated captured image in a pop-up window.

According to such control, it is possible to more efficiently view information on each captured image.

When any of the captured images displayed in the list is designated by the mouse pointer 3C04, the observation position display unit 1252 may change the magnification of the image display section 2A03 on the basis of the magnification of the captured image. For example, when the display image 2A04 is double-clicked, stage coordinates and magnification, which are specific information at the time of capturing the double-clicked display image 2A04, are reflected in the display settings of the image display section 2A03, and the magnification and coordinates of the image display section 2A03 are switched so that the display image 2A04 is appropriately displayed.

As a specific example, the magnification of the image display section 2A03 is changed such that a captured image is displayed in a predetermined size. The changed display is, for example, as shown in FIG. 2A. As a specific example, it is assumed that the visual field of the captured image is F1, the predetermined size in which the captured image should be displayed is S1, and the size of the image display section 2A03 is S2. In this case, the magnification of the image display section 2A03 is changed such that the visual field F2 of the image display section 2A03 is F2=F1×S2/S1.

According to such control, the magnification of the image display section 2A03 is changed on the basis of the size of the captured image, and thus a relationship between these images can be more easily grasped.

Here, in order to accurately display a background image and a captured image captured by the charged particle beam device 100 on the image display section 2A03, it is necessary to associate (align) the stage coordinates of the charged particle beam device 100 with the display coordinates of the image display section 2A03.

This association method can be appropriately designed by a person skilled in the art on the basis of known technology, and it is conceivable to use the addition theorem of trigonometric functions as an example. When the coordinates of an image are (coordinate X, coordinate Y, rotation angle R) and a stage rotation direction of the charged particle beam device 100 is counterclockwise (clockwise is positive), the display coordinates (coordinate X′, coordinate Y′, rotation R′) of an image on the image display section 2A03 can be obtained by the following formula.

$${X}^{′} = X \cdot cos ( - R ) - Y \cdot sin ( - R ) \qquad ( Formula 1 )$$

$${Y}^{′} = X \cdot sin ( - R ) + Y \cdot cos ( - R ) \qquad ( Formula 2 )$$

$${R}^{′} = - R \qquad ( Formula 3 )$$

When the display position of the image display section 2A03 is switched to the above (coordinate X′, coordinate Y′, rotation R′), the position of the captured image is displayed. Next, in order to display the image at an appropriate display magnification (for example, a ratio of 1:1), it is necessary to match a resolution Reso of one pixel of the image with a resolution Reso′ of one pixel of the image display section 2A03.

$$Reso = {Reso}^{′} \qquad ( Formula 4 )$$

Here, when the number of pixels and the visual field of the image display section 2A03 are W′ and FOV′, and the number of pixels and the visual field, which are attribute information of an image, are W and FOV, the following formula is obtained from Formula 4.

$$F O V / W = F O {V}^{′} / {W}^{′} \qquad ( Formula 5 )$$

In order to establish the above equation (display the image at a ratio of 1:1), it is necessary to change the resolution Reso per pixel of the image. However, since the visual field FOV of the image is specific information at the time of imaging and is not usually changed, information that is changed is the number of pixels W. By performing image resizing, such as an enlargement/reduction process and an interpolation process, the number of pixels W of the image can be changed, and as a result, the image is resized on the image display section 2A03 and can be displayed at an appropriate display magnification (ratio of 1:1). Here, an example in which the image is displayed at a ratio of 1:1 is described, but other ratios are also conceivable.

FIG. 3H is an example of a screen when the image name list display switching section 2A01 is switched to tag name (“Tag”) display. When a grouping process is performed manually or on the basis of grouping conditions on an input display image, a group name 603 that is set by the grouping page selection unit 604 of the setting screen 600 is associated with a tag name 3H02. In this manner, the observation assistance device stores the name of a group of captured images in association with tag names of the captured images. An image name 3H01 of an image that is input to the image display section 2A03 is displayed in a tree structure for each tag name 3H02.

According to such a configuration, it becomes easier to manage captured images in units of groups.

Associating the tag name 3H02 with the group name 603 may be performed by using the group name at the time of grouping as the tag name (examples of FIGS. 6 and 3H), or a name different from the group name may be given as the tag name.

A tag group representative image display button 3H03 is provided next to each tag name 3H02, and when this button is clicked, it is possible to switch between display and non-display of a representative image of the group.

Furthermore, a folder may be generated for each tag name 3H02, and captured images having the same tag name may be stored in the same folder (that is, the captured images may be divided into albums).

The image name 3H01 according to this example is the name of an image that is input into the image display section 2A03, and is information given when the image is acquired. The tag name 3H02 according to this example is additional information or a keyword other than the image name given to the image, and may usually be given information related to the content or characteristics of the image, such as the name of the group to which the image belongs. The group name 603 according to this example is a name that can be set by the grouping page selection unit 604 on the setting screen 600, and is a collective name for a group of images that have been grouped into the same group on the basis of grouping conditions.

### Major Effects of Present Example

By grouping captured images, it is possible to group similar images, making it easier to organize information. When a representative image is selected from the group, other images are displayed in a reduced size or are not displayed while controlling the representative image to a size that is easy to view due to a change in the display magnification of the image display section 2A03, and thus the image display section 2A03 is simplified and it is possible to grasp an observation position and analysis information of the representative image, which is a target image, in a short period of time. Furthermore, it is possible to easily confirm images in the same group by a slide show of group images, and thus it is easy to specify the observation position or image information of the target display image.

### Example 3

Example 3 of the present invention will be described below. Descriptions of parts that are in common with those in Examples 1 and 2 may be omitted.

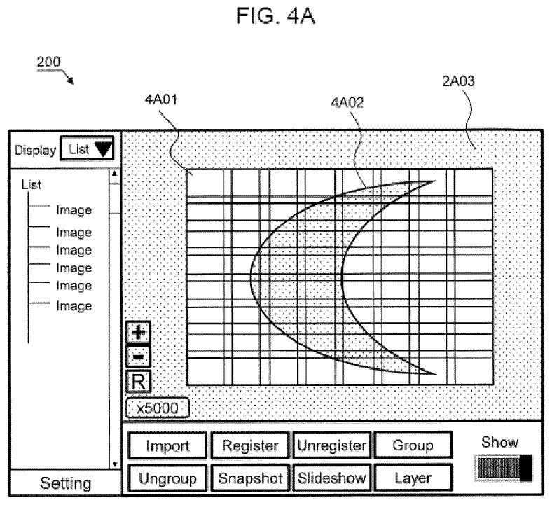

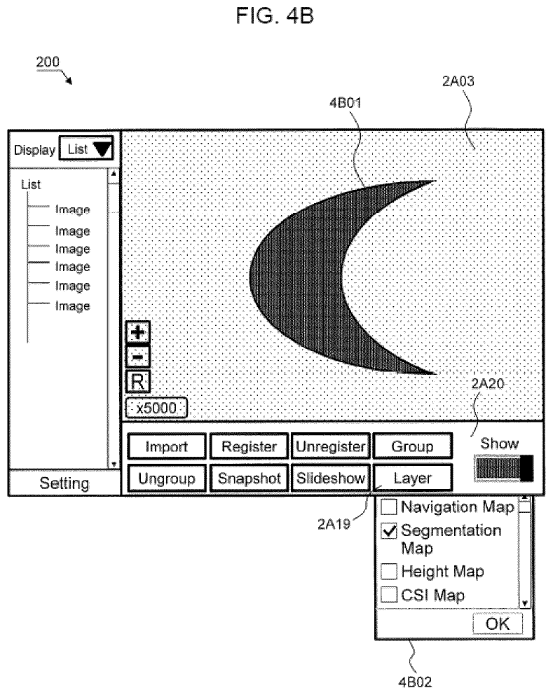

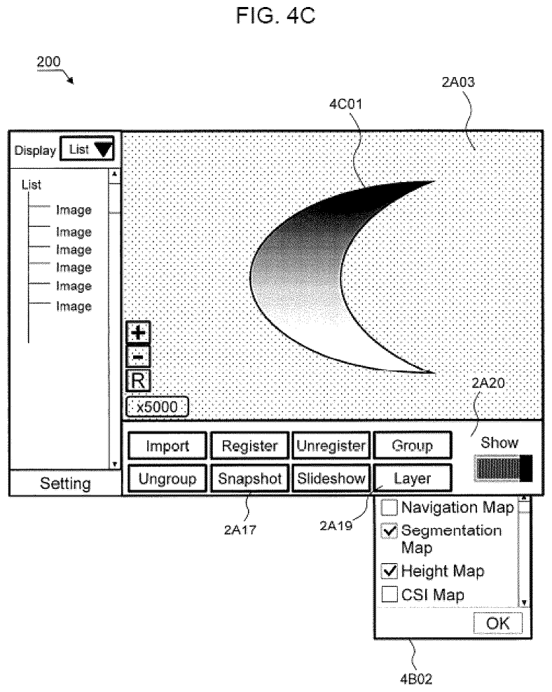

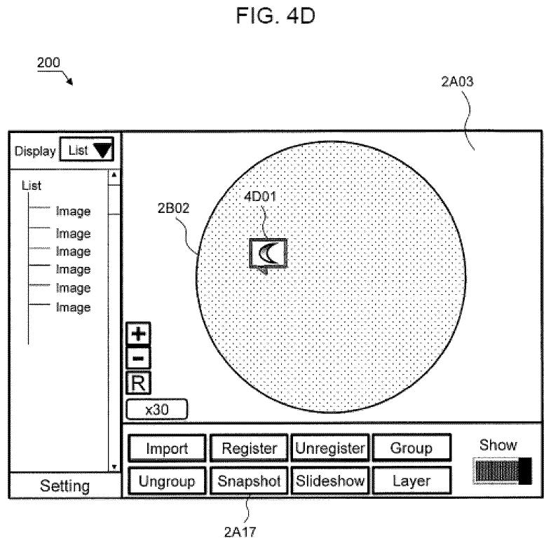

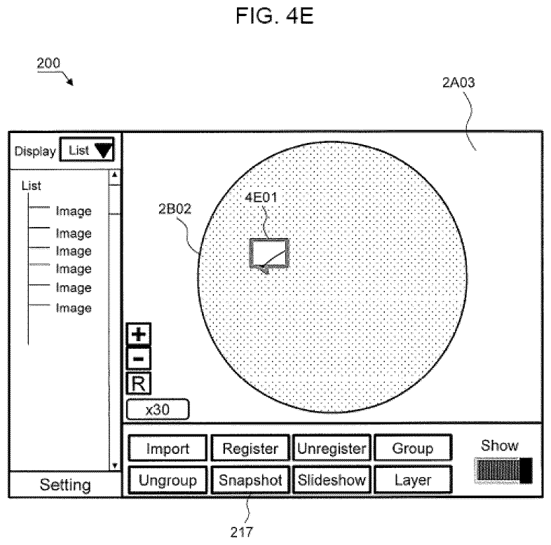

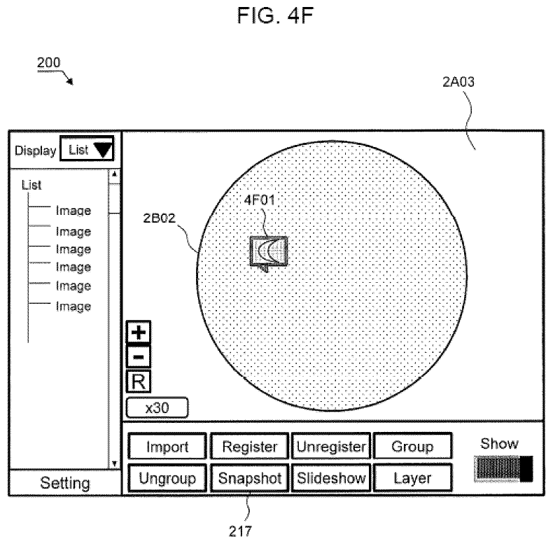

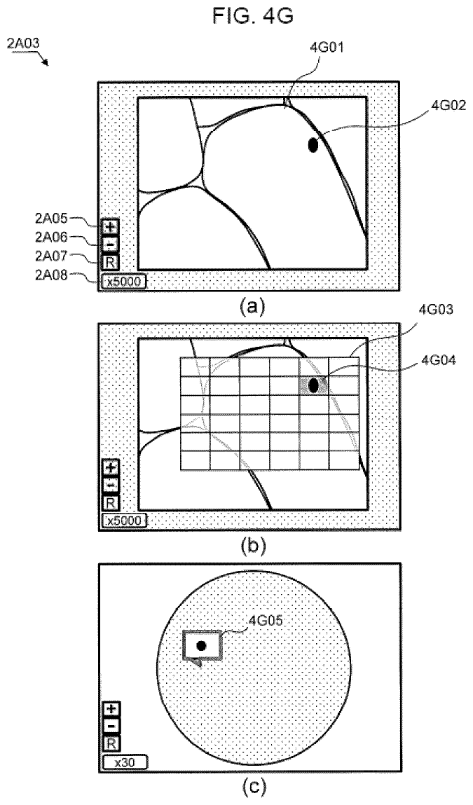

FIGS. 4A to 4G are examples of an observation position display screen of a charged particle beam device 100 according to Example 3 of the present invention. When a consecutive captured image group 4A01 in a target region 4A02 of a continuous sample designated by the charged particle beam device 100 is input to the image display section 2A03, the resulting display example is as shown in FIG. 4A. The target region 4A02 means, for example, a region of the sample that has a specific structure and is distinguishable from other regions on the image, but the present invention is not limited thereto.

Here, when an analysis file for extracting the target region 4A02 is read using analysis file settings of the setting screen 600, image processing including a binarization process, a target region search process, and the like is performed on the consecutive captured image group 4A01, and a segmentation region (predetermined region) is determined. In this manner, the observation assistance device can extract the target region 4A02 as a segmentation region.

The extracted target region 4A02 can be stored as a display layer separate from the image display section 2A03. The “display layer” in this example refers to a virtual transparent sheet on which an image or a map can be displayed on the image display section 2A03. Any number of display layers can be superimposed on the image display section 2A03, image processing can be performed on each display layer, and operations such as image editing can be performed on each display layer.

Working distance information, which is attribute information of a consecutive captured image group, may be acquired, parts corresponding to the target regions 4A02 may be visualized by color shading or the like, and a pseudo height map of the target regions 4A02 may be generated as a separate display layer.

In the example of FIG. 4A, the extraction of the target region 4A02 from the consecutive captured image group 4A01 is shown, but the target region may be extracted from a single image, and the present invention is not limited to that shown in the drawing. A specific process for extracting a specific target region as a segmentation region on the basis of one or more images can be appropriately designed by a person skilled in the art on the basis of known technology, etc.

Regarding each display layer, it is possible to switch between display and non-display of the display layer of the consecutive captured image group 4A01 on the image display section 2A03 by operating an image display toggle button, a check box, or the like.

As shown in FIG. 4B, when a display layer setting button 2A19 of the operation section 2A20 is clicked, a display layer setting window 4B02 is displayed. By checking a check box for a segmentation map in the display layer setting window 4B02, a segmentation map 4B01 of the target region 4A02 is displayed on the image display section 2A03. The segmentation map 4B01 can be configured as a display layer that indicates with a binary value, for example, whether each pixel is included in the segmentation region.

As shown in FIG. 4C, when a check box for a height map is further checked, a composite display layer 4C01 of the segmentation map 4B01 of the target region 4A02 and a height map is displayed on the image display section 2A03. In addition to the segmentation map and the height map, an imaging time map generated from the imaging time, a signal map generated from signal information, and the like may be displayed.

Furthermore, output results of other systems (for example, a white light interference microscope, an atomic force microscope or a focused ion beam device, an optical microscope, a fluorescent microscope, image processing software, and the like) may be displayed as a display layer. In this manner, the observation assistance device stores information of a sample which is output from devices other than the charged particle beam device 100 as a display layer.

The example of FIG. 4G shows a representative image selection process and a grouping process by utilizing the display layer of the image display section 2A03. For example, when a resin slice stained with a dye suitable for an observation target 4G02 is observed using an optical microscope, an optical microscope image 4G01 (background image) of the stained observation target can be output.

As shown in FIG. 4G(a), the optical microscope image 4G01 is input to the image display section 2A03 and displayed as a display layer. Furthermore, an alignment process is performed to match observation position information of the optical microscope with stage position information of the charged particle beam device, and a stage is externally controlled, thereby enabling high-resolution structural observation of the same location by the charged particle beam device 100.

As shown in FIG. 4G(b), in the charged particle beam device 100, a region including a stained target in the optical microscope image is continuously captured in a plurality of visual fields at a higher magnification, and an acquired consecutive captured image group 4G03 (consecutive captured image group No. 2) is displayed on the image display section 2A03. Here, the alignment process for matching the observation position information of the optical microscope with the stage position information of the charged particle beam device is given as an example, but a sample holder that does not require an alignment process may be used, and the present invention is not limited to this example.

Here, the position of the stained observation target can be obtained by performing image processing including a binarization process and a target search process on the optical microscope image 4G01 (display layer). Since the observation position information of the optical microscope image 4G01 (display layer) is synchronized with the stage coordinates of the charged particle beam device 100, an image (captured image) of the charged particle beam device 100 which is captured at the same position as the stained observation target can be used as a condition achievement image 4G04.

As shown in FIG. 4G(c), when the display magnification of the image display section 2A03 is reduced to a low magnification, for example, 30 times, it is possible to display the condition achievement image 4G04 as a representative image 4G05 (representative image No.4) in a size that is easy to view.

Furthermore, similar to the selection of a representative image, it is possible to perform a grouping process on a plurality of captured images by utilizing image processing and a display layer. For example, a case where a target region part in the display layer is continuously captured at a high magnification by the charged particle beam device 100 over a wider range than the target region is considered.

The observation assistance device performs image processing including a binarization process and a target search process on the display layer to obtain the range of a target region (segmentation region), thereby making it possible to group a group of captured images included within the range of the target region (segmentation region). For example, in a case where an imaging visual field is small for a specific region when an image of the specific region is captured under specific imaging conditions (for example, high magnification), it is necessary to capture the specific region with a plurality of imaging visual fields. For this reason, for example, the specific region (for example, a rectangular region including the entire segmentation region) is divided into a plurality of small sections (for example, rectangular sections arranged in a lattice), and captured images are obtained for the small sections. Then, among the captured images, those including the segmentation region are grouped into the same group.

In this manner, the observation assistance device extracts the segmentation region and groups the captured images on the basis of the segmentation region. According to such control, captured images related to the specific segmentation region can be automatically grouped, and the segmentation region can be viewed more efficiently.

The representative image selection processing unit 1223 may extract one image from the group of captured images grouped into the same group on the basis of a preset representative image selection condition (for example, extracting the latest image, or the like) or randomly, and set the extracted image as a representative image. That is, the representative image selection processing unit 1223 sets a captured image captured at a position corresponding to a target region (for example, a position including at least a part of the target region) as the representative image on the basis of a result of image processing for a specific target region of a display layer.

According to such control, the captured image in which the target region is captured can be automatically set as the representative image, and the target region can be efficiently observed.

Alternatively, the display magnification of the image display section 2A03 can be optimized to display the size of the target region, and then a snapshot of a plurality of images can be taken to set the snapshot image as the representative image, and the present invention is not limited to this example.

In this example, an optical microscope image is described as an example of a background image, but an output result of a white light interference microscope, an atomic force microscope or a focused ion beam device, an optical microscope, image processing software, or the like may be used as the background image, and the present invention is not limited to that shown in the drawing.

When a snapshot button 2A17 of the operation section 2A20 is clicked in the display state of the image display section 2A03 as shown in FIG. 4C, the display state of the image display section 2A03 is stored as a snapshot image. Then, the snapshot image can be displayed on the image display section 2A03.

That is, the display processing unit 1224 stores the display state of the observation position display unit 1252 as a snapshot image by taking a snapshot, and displays this snapshot image as a representative image (for example, in a reduced state like a snapshot image 4D01 in FIG. 4D) on the observation position display unit 1252. A display method (size control, and the like) of the snapshot image can be the same as that for the captured image. At this time, the magnification and visual field when the snapshot image is captured can be set to values equal to the magnification and visual field of the image display section 2A03 when the snapshot image is acquired.

As shown in FIG. 4D, when the snapshot image 4D01 is registered as a representative image, even when the magnification of the image display section 2A03 is set to be extremely low, information confirmation and position identification can be easily performed from the snapshot image 4D01 that displays a composite layer of a target region.

The number of representative images related to the target region may be one or two or more. In addition, as shown in FIGS. 4E and 4F, the representative image of the target region may be a representative image 4E01 selected from among the captured images included in a consecutive captured image group, or a representative image 4F01 that displays a connected image in which consecutive captured image groups are arranged in accordance with an imaging position. Similarly, even when the magnification of the image display section 2A03 is set to be extremely high, a snapshot image can be displayed on the auxiliary display 2E01.

### Major Effects of Present Example

When a target region of a sample is extracted by performing image processing, and various layers are further generated therefor using attribute information and analysis information of an image, information of the target region is visualized, and thus the state can be easily grasped. In addition, it is possible to automatically perform a grouping process for a group of captured images captured by the charged particle beam device 100 and a representative image selection process by performing image processing and the like on the layers of the target region. Furthermore, when a snapshot image is registered as a representative image, even when the magnification of the image display section is significantly different from the magnification of the target region, it is possible to confirm the information and state of the target region only by viewing the representative image at a glance.

### Example 4

Example 4 of the present invention will be described below. Descriptions of parts that are in common with those in Examples 1, 2, and 3 may be omitted.

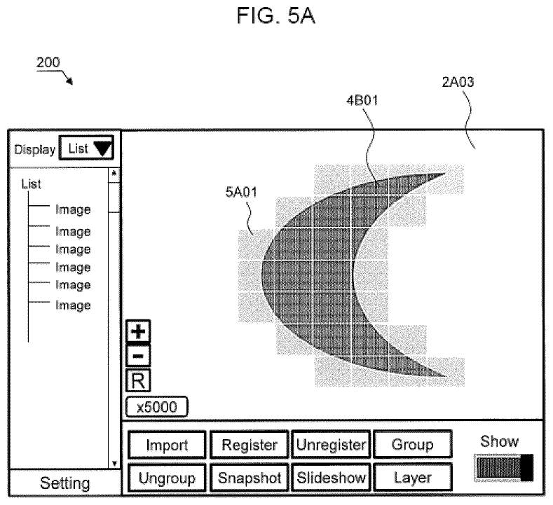

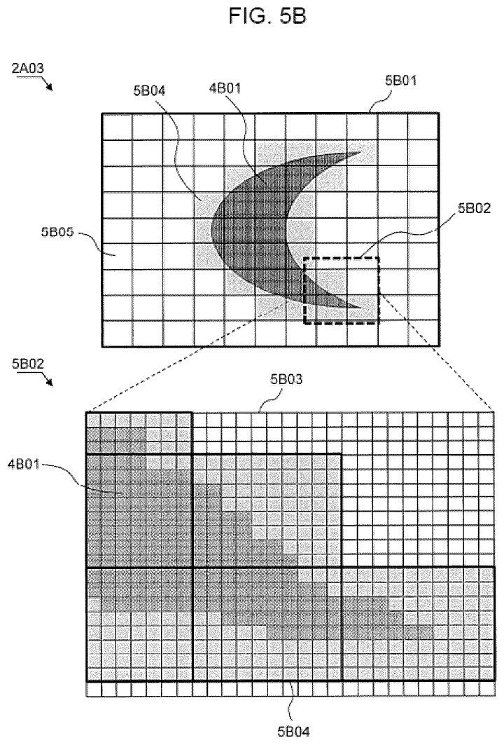

FIGS. 5A and 5B are examples of an observation position display screen of a charged particle beam device according to Example 4 of the present invention. In the example of FIG. 5A, when new imaging conditions, such as a different magnification, are set for the target region 4A02 of the sample 108, it is possible to automatically set a new consecutive captured candidate image group 5A01 that conforms to the shape of the target region 4A02 by using the segmentation map 4B01 of the target region 4A02.

A segmentation map is a map obtained by binarizing whether each pixel is included in a target region in order to separate a specific region (target region) from the background and visualize only the target region. The observation assistance device stores a segmentation region (or segmentation map) as a display layer.

According to such control, the segmentation map can be displayed to be superimposed on other information (for example, the arrangement state of small sections), making it possible to more easily grasp a relationship between the target region and other structures (for example, small sections).

In this example, as shown in FIG. 5B, when image processing such as a binarization process is performed on the segmentation map 4B01 of the target region 4A02 (see FIG. 4A), the segmentation map 4B01 becomes a binarized pixel map 5B03 of 0 (white and light gray) and 1 (dark gray). A part including a part of the target region 4A02 becomes 1 (dark gray).

Here, it is possible to automatically set an imaging visual field mesh 5B01 from new imaging conditions, for example, new setting values such as a magnification, a visual field overlap rate of images to be captured, and an imaging range. When the imaging visual field mesh 5B01 is superimposed on the segmentation map 4B01, it is as shown in an enlarged image of a part of interest 5B02 in FIG. 5B.

When any one of small sections of the imaging visual field mesh 5B01 overlaps the dark gray part (indicating the target region 4A02) of the binarized pixel map 5B03 of the target region 4A02 (for example, when the dark gray part includes at least one pixel), the small section is set as the imaging visual field 5B04, that is, imaging processing is performed on the small section. On the other hand, when the small section does not overlap the dark gray part of the binarized pixel map 5B03 (when the small section does not include any dark gray part), the small section is set as a non-imaging visual field 5B05 of the imaging visual field mesh 5B01.

In this manner, the observation assistance device determines an imaging region group corresponding to the target region (segmentation region) on the basis of an overlapping determination result between the result of image processing for the target region (segmentation region) and an imaging visual field mesh formed in accordance with imaging conditions.

In this manner, it is possible to automatically set the new consecutive captured candidate image group 5A01 according to the shape of the target region 4A02 by utilizing the imaging visual field mesh 5B01 set in accordance with the new imaging conditions and the segmentation map 4B01.

In this example, the new consecutive captured candidate image group 5A01 is automatically set in accordance with the shape of the target region 4A02, but it does not need to conform to the shape of the target region, or a single image may be automatically set instead of a consecutive captured image group, and the present invention is not limited to that shown in the drawing.

### Major Effects of Present Example

It is possible to efficiently re-image a target region with high resolution by automatically setting the new consecutive captured candidate image group 5A01 for the target region 4A02.

### REFERENCE SIGNS LIST

100: charged particle beam device
101: sample chamber
102: charged particle beam optical system
103: sample stage
104: stage
105: detector
106: optical camera
107: vacuum pump
108: sample
110: charged particle beam imaging device
111: memory
120: arithmetic control unit (observation assistance device)
121: CPU
122: main storage device
123: secondary storage device
124: input unit
125: display unit (observation assistance device)
130: stage control device
131: coordinate storage unit
132: control unit
133: drive unit
140: vacuum control device
141: memory
150: optical imaging device
151: memory
161: charged particle source
162: condenser lens
163: deflector
164: objective lens
170: optical system control device
171: memory
200: observation position display screen
300: image analysis result display screen
600: settings screen
601: image setting tab
602: interest image setting tab
603: group name
604: grouping page selection unit
605: group page addition button
606: group page deletion button
607: grouping condition setting radio button
608: analysis target setting unit
609: condition setting unit
610: relationship setting unit
611: threshold value setting unit
612: inter-condition relationship setting unit
613: representative image selection condition setting unit
614: analysis file setting radio button
615: file path input unit
616: file selection button
1221: information processing unit
1222: image grouping processing unit
1223: representative image selection processing unit
1224: display processing unit
1251: observation image display unit
1252: observation position display unit
2A01: image name list display switching section
2A02: image name list display section
2A03: image display section
2A04: display image (captured image)
2A05: magnification increase button
2A06: magnification decrease button
2A07: magnification reset button
2A08: magnification display section
2A09: condition achievement image (representative image)
2A10: image input button
2A11: representative image registration button
2A12: representative image cancellation button
2A13: grouping button
2A14: representative image display toggle button
2A15: input image setting section
2A16: grouping cancellation button
2A17: snapshot button
2A18: slideshow button
2A19: display layer settings button
2A20: operation section
2B01: representative image
2B02: displayed sample map
2C01: representative image
2D01: representative image
2D02: position display marker
2E01: auxiliary display
2E02: representative image
3A01: target image display section
3A02: target image
3A03: left button
3A04: right button
3A05: image analysis information display section
3A06: particle analysis information display section
3A07: image of interest (representative image)
3B01: reduced image
3B02: non-display image
3C01: display image (captured image)
3C02: condition achievement interest target
3C03: image of interest (representative image)
3C04: mouse pointer (position input pointer)
3E01: slider bar
3E02: enlarged representative image
3F01: group image list display section
3G01: image information display pop-up window
3H01: image name
3H02: tag name
3H03: representative image display button
4A01: consecutive captured image group
4A02: target region (predetermined region)
4B01: segmentation map
4B02: display layer setting window
4C01: composite display layer
4D01: snapshot image (representative image)
4E01: representative image
4F01: representative image
4G01: optical microscope image
4G02: observation target
4G03: consecutive captured image group
4G04: condition achievement image (captured image)
4G05: representative image
5A01: new consecutive captured candidate image group
5B01: imaging visual field mesh
5B02: part of interest
5B03: binarized pixel map
5B04: imaging visual field
5B05: non-imaging visual field

1. An observation assistance device for a sample, comprising:
an observation position display unit that displays, in correspondence with an image display section, positions of a plurality of captured images of the sample which are captured by a charged particle beam device;
a display processing unit that controls the observation position display unit; and
a representative image selection processing unit that selects a representative image on the basis of the plurality of captured images,
wherein the display processing unit controls the representative image to a size that is easy to view and displays the representative image on the observation position display unit in response to a change in a magnification of the image display section.

2. The observation assistance device according to claim 1, wherein controlling the representative image to a size that is easy to view includes controlling the representative image to a specific size.

3. The observation assistance device according to claim 1, wherein controlling the representative image to a size that is easy to view includes controlling the representative image to a size of a predetermined auxiliary display and displaying the representative image on the auxiliary display.

4. The observation assistance device according to claim 1, further comprising an image grouping processing unit that groups the captured images,
wherein the observation assistance device controls the captured images other than the representative image to a size that corresponds to the magnification of the image display section, or omits display of the captured images other than the representative image in accordance with the magnification of the image display section.

5. The observation assistance device according to claim 1, wherein the representative image selection processing unit selects one of the captured images indicated by a manual input as the representative image, or selects the representative image in accordance with representative image selection conditions on the basis of image analysis information or image attribute information of the captured images.

6. The observation assistance device according to claim 1, wherein the representative image selection processing unit selects any one of the captured images as the representative image, or selects an image of interest occupying a predetermined region in any one of the captured images as the representative image.

7. The observation assistance device according to claim 1, further comprising an image grouping processing unit that groups the captured images,
wherein the image grouping processing unit groups the captured images indicated by a manual input into the same group, or groups the captured images on the basis of image analysis information or image attribute information of the captured images.

8. The observation assistance device according to claim 1, further comprising an image grouping processing unit that groups the captured images,
wherein the representative image selection processing unit sets one of the grouped captured images which is designated by a position input pointer as the representative image, or selects the representative image from among the grouped captured images by switching between the captured images for a predetermined time.

9. The observation assistance device according to claim 1, further comprising an image grouping processing unit that groups the captured images,
wherein the representative image selection processing unit sets one of the grouped captured images which is designated by a position input pointer as the representative image, and
controlling the representative image to a size that is easy to view includes enlarging the representative image in response to being designated by the position input pointer.

10. The observation assistance device according to claim 9, wherein the observation position display unit displays a slider bar in relation to the enlarged representative image.

11. The observation assistance device according to claim 1, further comprising an image grouping processing unit that groups the captured images,
wherein the observation assistance device displays a list of the captured images that belong to the same group as the representative image.

12. The observation assistance device according to claim 11, wherein the observation position display unit displays at least one of image attribute information and image analysis information for the designated captured image in a pop-up window in response to a position input pointer designating any one of the captured images displayed in the list.

13. The observation assistance device according to claim 11, wherein the observation position display unit changes a magnification of the image display section on the basis of a magnification of the captured image in response to a position input pointer designating any one of the captured images displayed in the list.

14. The observation assistance device according to claim 1, further comprising an image grouping processing unit that groups the captured images,
wherein the observation assistance device stores a name of the group of the captured images in association with a tag name of the captured image.

15. The observation assistance device according to claim 1, wherein the display processing unit takes a snapshot of a display state of the observation position display unit, stores it as a snapshot image, and displays the snapshot image on the observation position display unit.

16. An observation assistance device for a sample, comprising:
an observation position display unit that displays, in correspondence with an image display section, positions of a plurality of captured images of the sample which are captured by a charged particle beam device;
a display processing unit that controls the observation position display unit; and
a representative image selection processing unit that selects a representative image on the basis of the plurality of captured images,
wherein the observation assistance device extracts a predetermined region and groups the captured images on the basis of the predetermined region.

17. The observation assistance device according to claim 16, wherein the observation assistance device stores the predetermined region as a display layer.

18. The observation assistance device according to claim 16, wherein
the observation assistance device stores information on the sample which is output from a device other than the charged particle beam device as a display layer, and
the representative image selection processing unit sets the captured image captured at a position corresponding to a specific target region as the representative image on the basis of a result of image processing for the target region of the display layer.

19. The observation assistance device according to claim 18, further comprising an image grouping processing unit that groups the captured images included within the range of the target region,
wherein the representative image selection processing unit selects the representative image from among the captured images grouped into the same group on the basis of a representative image selection condition.

20. The observation assistance device according to claim 18, wherein the observation assistance device determines an imaging region group corresponding to the target region on the basis of an overlapping determination result between the result of the image processing for the target region and an imaging visual field mesh formed in accordance with an imaging condition.
